(19) United States
(12) Patent Application Publication
(10) Pub. No.: US 2024/0291055 A1
(43) Pub. Date: Aug. 29, 2024

(54) REDUNDANCY FOR BATTERY PROTECTION

(71) Applicant: BAE SYSTEMS CONTROLS INC., Endicott, NY (US)

(72) Inventors: Brian Cortes, Endicott, NY (US); Matthew S. Boecke, Endicott, NY (US); Robert J. Arbogast, Binghamton, NY (US); Michael Mallery, Apalachin, NY (US); Laura Dionisio, Endicott, NY (US)

(73) Assignee: BAE Systems Controls Inc., Endicott, NY (US)

(21) Appl. No.: 18/115,228

(22) Filed: Feb. 28, 2023

(51) Int. Cl. H01M 10/48; H01M 10/42; H01M 50/204; H01M 50/342; H01M 50/578; H01M 50/581; H02H 1/00; H02H 7/18

(52) U.S. Cl. CPC H01M 10/482; H01M 10/425; H01M 10/486; H01M 50/204; H01M 50/3425; H01M 50/578; H01M 50/581; H02H 1/0007; H02H 7/18; H01M 2010/4278; H01M 2200/20

(57) ABSTRACT

A battery assembly includes an enclosure including a plurality of battery cells, and a sensor within the enclosure. The sensor is configured to measure a parameter within the enclosure, and generate a sense signal. The battery assembly further includes a processor within the enclosure, wherein the processor is configured to process the sense signal and generate information associated with the sense signal. A first communication link is configured to transmit, from the enclosure to a system that is external to the enclosure, a discrete signal indicative of whether the sense signal indicates a fault condition. A second communication link is configured to transmit, from the enclosure to the system, a digital signal including the information. Thus, transmitting the discrete signal over the first communication link and the information associated with the sense signal over the second communication link provides redundancy and improves reliability of the battery assembly.

### TECHNICAL FIELD

The present disclosure relates generally to battery technology, and more particularly to protection of battery packs.

### BACKGROUND

A lithium-ion battery or Li-ion battery is a type of rechargeable battery with a high energy density and generally no memory effect. The batteries can be used individually, or together in groups that are packaged in a battery pack. Li-ion batteries and battery packs are commonly used in portable electronic devices (e.g., cell phones), electric vehicles, and cordless power tools for consumers, for example. Li-ion battery technology is also used in military and aerospace applications.

The Li-ion cell provides electric current when lithium ions move through an electrolyte from a negative electrode to a positive electrode. Lithium ions move in the reverse direction when charging the cell. In some examples, the positive electrode includes lithium cobalt oxide (LiCoO₂), lithium iron phosphate (LiFePO₄), or lithium manganese oxide (LiMn₂O₄ or Li₂MnO₃). The negative electrode commonly includes graphite, for example. The electrolyte can be a mixture of organic carbonates and lithium ion complexes. For example, the electrolyte can include ethylene carbonate or diethyl carbonate. Lithium ion cells can have a variety of form factors, including a cylinder, a flat, a pouch, and a rigid plastic case with threaded terminals. A cylindrical lithium-ion cell usually includes a metal container that provides the primary structure to the cell and serves as the negative electrode. The container can be made of aluminum or steel, for example. An electrode assembly includes current collector sheets separated by porous membranes rolled into a cylindrical shape. The electrode assembly is placed in the container and functions as the electrical energy storage component. The current collectors may include copper or aluminum foil coated with an active material, and the porous membranes can be a polymer or ceramic, for example. An electrolyte fills the remaining volume of the container and permeates the active material on the current collectors and separators. A cap, which serves as the positive electrode, is crimped in place on the top of the can to complete the cell and enclose the electrode assembly within the container. There remain several non-trivial issues with respect to operating battery packs, such as lithium-ion battery packs.

### BRIEF DESCRIPTION OF THE DRAWINGS

FIG. 1 illustrates a battery assembly comprising a plurality of battery cells within an enclosure, wherein the battery assembly further includes (i) a plurality of sensors to sense a corresponding plurality of parameters associated with the battery cells and/or the enclosure, and (ii) a processor within the enclosure, wherein data from one or more of the plurality of sensors are redundantly transmitted from the enclosure to a system that is external to the enclosure, in accordance with an embodiment of the present disclosure.

FIG. 2A illustrates a plot depicting a sense signal output by an outgas sensor of the battery assembly of FIG. 1, in accordance with an embodiment of the present disclosure.

FIG. 2B illustrates a plot depicting a sense signal output by a pressure relief sensor of the battery assembly of FIG. 1, in accordance with an embodiment of the present disclosure.

FIG. 2C1 illustrates a plot depicting a sense signal output by a temperature sensor of the battery assembly of FIG. 1, in accordance with an embodiment of the present disclosure.

FIG. 2C2 illustrates a plot depicting a discrete signal generated by a comparator, based on the sense signal of FIG. 2C1, in accordance with an embodiment of the present disclosure.

FIG. 2D1 illustrates a plot depicting a voltage sense signal output by a voltage sensor of the battery assembly of FIG. 1, in accordance with an embodiment of the present disclosure.

FIG. 2D2 illustrates a plot depicting a discrete under-voltage signal generated by a comparator, based on the sense signal of FIG. 2D1, in accordance with an embodiment of the present disclosure.

FIG. 2E1 illustrates another plot depicting the voltage sense signal output by the voltage sensor of the battery assembly of FIG. 1, in accordance with an embodiment of the present disclosure.

FIG. 2E2 illustrates a plot depicting a discrete over-voltage signal generated by a comparator, based on the sense signal of FIG. 2E1, in accordance with an embodiment of the present disclosure.

FIG. 3 illustrates communication between a processor of a battery assembly and a system that is external to an enclosure, in accordance with an embodiment of the present disclosure.

FIG. 4 illustrates a battery assembly that is at least in part similar to the battery assembly of FIGS. 1 and 3, wherein in the battery assembly of FIG. 4, one or more comparators receive corresponding one or more sense signals directly from corresponding one or more sensors (e.g., by bypassing the processor), in accordance with an embodiment of the present disclosure.

FIG. 5 illustrates a battery assembly that is at least in part similar to the battery assemblies of FIGS. 1, 3, and 4, wherein in the battery assembly of FIG. 5, one or more comparators of the battery assembly are realized by the processor (e.g., by software being executed within the processor) that is within the enclosure, in accordance with an embodiment of the present disclosure.

FIG. 6 illustrates a battery assembly that is at least in part similar to the battery assemblies of FIGS. 1, 3, 4, and 5, wherein in the battery assembly of FIG. 6, discrete signals are generated and transmitted over a dedicated communication link (e.g., dedicated for transmission of the discrete signals, and not digital data) by bypassing the processor, in accordance with an embodiment of the present disclosure.

FIGS. 7A and 7B illustrate the battery assembly of FIG. 1, along with operations of a switch within the enclosure of the battery assembly, where the switch is operable to disconnect the plurality of battery cells from a load external to the enclosure, in response to detection of a warning or a fault event from the battery assembly, in accordance with an embodiment of the present disclosure.

FIG. 8A illustrates a flowchart depicting a method for operating the battery assembly of FIGS. 1, 3, 4, 5, 6, 7A and 7B, in accordance with an embodiment of the present disclosure.

FIG. 8B illustrates a flowchart depicting a method for operating the battery assembly of FIGS. 1, 3, 4, 5, 6, 7A and 7B, in an event of (i) a failure in a communication link between the processor and the system, and/or (ii) a failure in the processor, in accordance with an embodiment of the present disclosure.

FIG. 8C illustrate a flowchart depicting a method for operating the battery assembly of FIGS. 1, 3, 4, 5, 6, 7A and 7B, in an event of (i) a failure in a communication link between the enclosure and the external system, and/or (ii) a failure in one or more of the comparators of the battery assembly, in accordance with an embodiment of the present disclosure.

The figures depict various embodiments of the present disclosure for purposes of illustration only and are not necessarily drawn to scale. Numerous variations, configurations, and other embodiments will be apparent from the following detailed description.

### DETAILED DESCRIPTION

Disclosed are methodologies and structures for introducing redundancies in processing and/or communication of data from sensors deployed within a battery assembly to a battery control system. In accordance with some example embodiments, a battery assembly comprises an enclosure, and a plurality of battery cells within the enclosure. In some such embodiments, the battery assembly is a lithium-ion battery assembly, although other types of battery assembly (such as lead acid battery cells or hydrogen cells) may also benefit from the techniques described herein. A plurality of sensors is deployed within the battery assembly, e.g., to monitor one or more corresponding parameters within the battery assembly. Examples of sensors used include a pressure relief sensor, an outgas sensor, a temperature sensor, a voltage sensor, and/or another appropriate sensor that may be deployed within a battery assembly, e.g., to ensure safe operation of the battery assembly. A processor is mounted within the battery assembly, where the processor receives and processes sense signals from the sensors, to generate digital information that includes data associated with the sense signals.

In an example, one or more sense signals from corresponding one or more corresponding sensors can be discrete sense signals (e.g., the outgas sensor may output a discrete sense signal indicating whether or not an outgas event has been detected). Such discrete sense signals provide indications of a battery failure event (e.g., an outgas event is a battery failure event). Some other sense signals may be analog sense signals (e.g., the temperature sensor may output an analog sense signal indicating a temperature of a location within the battery assembly). In an example, a comparator receives a corresponding analog sense signal, compares the analog sense signal to a threshold value of the corresponding parameter, and generates a corresponding discrete sense signal. For example, a comparator may compare the temperature output of the temperature sensor with a temperature threshold, to generate a corresponding discrete sense signal indicating whether or not an over-temperature event has been detected.

In some examples, the discrete sense signals are transmitted over a first communication link from the battery enclosure to a system external to the battery. In some such examples, such transmission of the discrete sense signals may bypass the processor, and may be transmitted independent of the operation of the processor. Also, in an example, the digital information generated by the software being executed by the processor (e.g., where the digital information includes data associated with the sense signals) are transmitted by the processor to the system external to the battery, e.g., over a second communication link that is different from the above described first communication link. Thus, communicating data from the sensors to the system through the two different and independent communication links provides redundancy, and improves reliability of the entire system.

In some examples, the enclosure also includes a switch (such as a contactor) to selectively couple the plurality of battery cells to a load external to the enclosure. The switch may be controlled by the system external to the enclosure, and/or by the processor within the enclosure. In some such examples, during normal operation of the battery assembly (e.g., when no warning or fault event has been detected), the switch is in a closed state, and couples the battery cells to the load. However, responsive to a detection of a fault condition, the switch transitions to an open state, and disconnects the battery cells form the load, thereby reducing possibilities of thermal runaway and consequent reduction in possibilities of fire hazards. Numerous variations and embodiments will be apparent in light of the present disclosure.

### General Overview

As mentioned herein above, there remain several non-trivial issues with respect to operating battery packs, such as lithium-ion battery packs. One challenge of lithium-ion battery technology is thermal management. An ongoing concern is the possibility of thermal runaway during use, handling, and/or transportation of lithium-ion batteries. Thermal runaway occurs when a series of self-sustaining exothermic side-reactions lead to total failure of the cell and, in some cases, fire and/or explosion. A battery cell undergoing a thermal runaway may emit hot gases, flames, and high-velocity jets of molten particulate matter, referred to as ejecta. Lithium-ion batteries have the potential to experience thermal runaway due to the chemical nature of the lithium-ion technology. Although significant progress has been made over time to improve cell performance (e.g., reducing capacity fade, increasing available power, etc.), challenges of thermal runaway and its propagation persist. For example, the materials and construction of individual battery cells or of the battery pack can result in a localized hot spot or heating that results in cell failure. Also, over-constraining a battery cell can result in large pressure gradients that lead to failure of mechanical components, such as plates and fasteners around a battery cell. Similarly, not letting the ejecta escape can lead to instantaneous formation of local hot spots that can trigger thermal runaway in nearby battery cells. A need exists for structures and methodologies for sensing parameters within a battery assembly, and for mitigating the propagation of thermal runaway in lithium-ion battery packs, e.g., during a battery failure event.

Accordingly, techniques are described herein to form a battery assembly in which sensor data from the battery assembly is redundantly processed and communicated, so as to mitigate or reduce safety hazards, such as chances of thermal runaway and any consequent fire hazards in the battery assembly. For example, sensor data is processed and communicated using two independent data paths to a control system, thereby increasing data processing and communication redundancy in the battery assembly, and reducing chances of catastrophic failure and consequent hazards of thermal runaway and fire within the battery assembly.

In some embodiment, the battery assembly comprises an enclosure that is substantially air-tight, and a plurality of battery cells within the enclosure. In some examples, the battery cells may be lithium ion battery cells, although other types of battery cells (such as lead acid battery cells or hydrogen cells) may also benefit from the techniques described herein.

The enclosure of the battery assembly includes a plurality of sensors. In an example, the plurality of sensors includes an outgas sensor and/or a pressure relief sensor. For example, during a faulty operation of a battery cell, gases may be released by the battery cell (referred to herein as “outgassing” of the battery cell), where examples of such released gases have been described herein below. Such released gases may increase gas pressure within the battery enclosure, and may aid in thermal runaway and fire hazard, as well as may cause structural damage to the enclosure. In one embodiment, a pressure relief device is mounted within the enclosure. In an example, the pressure relief device is a burst disc device, although other types of pressure relief device may also be used instead. The pressure relief device is configured to release gas pressure from the enclosure, e.g., by way of rupture of a diaphragm of the burst disc, responsive to the gas pressure exceeding a threshold due to outgassing of one or more battery cells during a fault condition.

In some embodiments, the pressure relief sensor within the enclosure is configured to output a pressure relief sense signal indicative of such a pressure relief event. For example, the pressure relief sense signal may be a discrete signal having a first state indicative of a normal condition of the pressure relief device, and a second state indicative of a rupture or burst of the pressure relief device, e.g., a pressure release failure event.

In some embodiments, the outgas sensor within the enclosure is configured to sense any outgassing within the enclosure, e.g., due to a fault condition of one or more battery cells. The outgas sensor is configured to output an outgas sense signal, where the outgas sense signal may be a discrete signal having a first state indicative of a normal condition (e.g., outgas detected is zero or less than a threshold ppm level), and a second state indicative of an outgas failure event (e.g., outgas detected is equal to or higher than the threshold ppm level).

In an example, the plurality of sensors includes one or more temperature sensors located in one or more locations within the enclosure. In an example, a temperature sense signal is an analog signal indicative of the measured temperature. In an example, a comparator receives the analog temperature sense signal, compares the analog temperature sense signal to a threshold temperature value, and generates a corresponding discrete temperature sense signal indicating whether or not an over-temperature event has been detected. For example, the discrete temperature sense signal may have a first state indicative of a normal condition (e.g., temperature less than the threshold temperature), and a second state indicative of an over-temperature failure event.

In an example, the plurality of sensors includes a voltage sensor to monitor an output voltage of the battery assembly (or monitor an interval voltage of the battery assembly). In an example, a voltage sense signal is an analog signal indicative of the measured voltage. In an example, a comparator receives the analog voltage sense signal, compares the analog voltage sense signal to a high threshold voltage and to a low threshold voltage, and generates (i) a corresponding discrete over-voltage sense signal indicating whether or not the voltage is higher than the high threshold voltage that results in an over-voltage event, and (i) a corresponding discrete under-voltage sense signal indicating whether or not the voltage is lower than the low threshold voltage that results in an under-voltage event. For example, the discrete over-voltage sense signal may have a first state indicative of a normal condition (e.g., voltage lower than the threshold high voltage), and a second state indicative of an over-voltage failure event (e.g., voltage higher than the threshold high voltage). Similarly, the discrete under-voltage sense signal may have a first state indicative of a normal condition (e.g., voltage higher than the threshold low voltage), and a second state indicative of an under-voltage failure event (e.g., voltage lower than the threshold low voltage).

In some embodiments, a processor within the enclosure is configured to receive and process the outputs of the various sensors. In an example, the processor (e.g., software executing within the processor) is configured to process the outputs of the various sensors, and generate digital information indicative of the sensor output.

In an example, the above described comparators are implemented by the processor (e.g., the comparators are software comparators). In another example, the comparators are separate from the processor. For example, the comparators may receive the analog sense signals form the sensors, e.g., by bypassing the processor. Thus, in such an example, even if the processor fails for some reason, such a processor failure may not affect the operation of the comparators.

Thus, as described above, two types of sensor data are now available: (i) discrete sense signals generated by the sensors and the comparators, and (ii) digital information generated by the software of the processor. Both the discrete sense data and the digital information are indicative of possible failure events detected by the sensors. Additionally, the digital information may include other types of information, such as an actual temperature and/or voltage sensed by the corresponding sensors, a level of the detected outgas, and/or other appropriate information included in the sensor data.

In some embodiments, the discrete sense signals generated by the sensors and the comparators are transmitted from the enclosure to an external system (e.g., that is external to the enclosure) over a first communication link. In some such embodiments, the discrete sense signals are transmitted from the sensors and the comparators, by bypassing the processor. For example, an appropriate circuit (such as a communication interface or a multiplexer, and/or another appropriate component) transmits the discrete sense signals over the first communication link from the sensors and the comparators to the external system, by bypassing the processor.

On the other hand, the processor transmits the digital information generated by the software over a second communication link that is different from the first communication link. For example, the first communication link is a discrete signal bus (e.g., adapted to transmit discrete signals), and the second communication link is a digital bus, such as Controller Area Network (CAN) bus.

Thus, communicating sensor data from the enclosure to the external system through two independent and different communication paths (such as the discrete sense signals transmitted over the first communication link, and the software generated digital information transmitted over the second communication link) improves reliability and redundancy of notifying the external system about the status of various parameters and fault conditions of the battery assembly, in an example. For example, even if the processor fails for some reason (e.g., due to overheating, stalling of the software, and/or other software and/or hardware issues), the external system continues to receive the discrete sense signals. Similarly, if transmission of the discrete sense signals fails for some reason, the processor continues to provide the software generated digital information to the external system.

In some examples, the enclosure also includes a switch to selectively couple the plurality of battery cells to a load external to the enclosure. In some such examples, the switch may be a contactor. The switch may be controlled by the external system, and/or by the processor within the enclosure. For example, the system and/or the processor generates one or more control signals, to control the operation of the switch.

During normal operation of the battery assembly (e.g., when no outgas event or pressure release event has been detected), the switch is in a closed state, and couples the battery cells to the load. However, responsive to a detection of a battery failure event (e.g., as indicated by the discrete sense signals and/or by the software generated digital information), the switch transitions to an open state, and disconnects the battery cells from the load. For example, responsive to a detection of an outgas event, a pressure release event, an over-temperature event, an under-voltage event, and/or an over-voltage event, the control signal(s) generated by the system and/or the processor instructs the switch to transition to the open state. Thus, upon detection of any such failure event(s), the battery is not loaded (due to the switch transitioning to the open state), thereby reducing possibilities of thermal runaway and consequent reduction in possibilities of fire hazards.

In accordance with some embodiments of the present disclosure, these various approaches can be used individually or together to mitigate or eliminate thermal runaway propagation in a battery pack assembly. Numerous variations and embodiments will be apparent in light of the present disclosure.

As used herein, the term “about” indicates that the value listed may be somewhat altered or otherwise within an acceptable tolerance, as long as the alteration does not result in nonconformance of the process or device. For example, for some elements the term “about” can refer to a variation of ±0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture

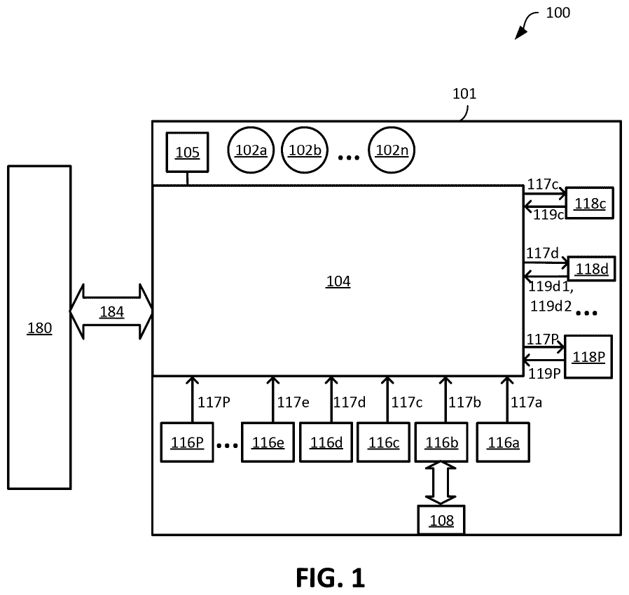

FIG. 1 illustrates a battery assembly 100 comprising a plurality of battery cells 102a, . . . , 102n within an enclosure 101, wherein the battery assembly 100 further includes (i) a plurality of sensors 116a, . . . , 116P to sense a corresponding plurality of parameters associated with the battery cells 102 and/or the enclosure 101, and (ii) a processor 104 within the enclosure 101, wherein data from one or more of the plurality of sensors 116a, . . . , 116P are redundantly transmitted from the enclosure 101 to a system 180 that is external to the enclosure 101, in accordance with an embodiment of the present disclosure.

In some examples, the walls of the enclosure 101 comprise metal, while in some other examples the walls of the enclosure 101 comprise non-metal. In an example, the walls of the enclosure 101 comprise a combination of metal and non-metal. In an example, the enclosure 101 is substantially air-tight. In one example, the enclosure 101 is fully air-tight or hermetically sealed. In another example, the enclosure 101 has some openings to allow the enclosure 101 and the battery cells 102a, . . . , 102n to “breathe,” e.g., to gradually exchange air or gas with the ambient (e.g., space outside the enclosure 101).

In one embodiment, individual battery cells 102 may comprise of any appropriate type of battery cell. For example, individual battery cells 102 may comprise lithium ion battery cells, although the battery cells 102 may be of another appropriate type, such as lead acid battery cells, or hydrogen cells. In an example, the plurality of battery cells 102a, . . . , 102n may be coupled in series and/or parallel connection. In an example, the battery cells 102a, . . . , 102n may be of appropriate size and may have any appropriate shape or form factor. In one embodiment, each battery cell 102 includes an electrolyte within a corresponding container, although the electrolyte and the containers of the battery cells 102 are not illustrated in FIG. 1.

In an example, a battery cell 102 may fail, for example, due to overcharging, over-voltage, under-voltage, over-heating, excessive discharging, and/or another appropriate reason. In one embodiment, the sensors 116a, . . . , 116P monitor corresponding P number of parameters within the enclosure 101. In one embodiment, the sensors 116a, . . . , 116P are within the enclosure 101, as illustrated in FIG. 1. However, in another example, one or more sensors may be outside the enclosure, e.g., attached to an outside surface of the enclosure 101.

The sensors 116a, . . . , 116P may be appropriate types of sensors. Some example types of sensors are described herein below. However, other appropriate types of sensors, e.g., those used within a battery cell enclosure and/or those used for battery cell protection, may also be possible.

In an example, the sensor 116a is an outgas sensor 116. In an example, out-gassing (also sometimes referred to as off-gassing) of a battery cell may occur during a beginning stage of battery failure. When out-gassing of the battery cell occurs, if no actions are taken to remedy the cause of the failure, the battery cell may proceed to thermal runaway, and may even burst into fire. In an example, out gassing may result from vapor of the battery cell electrolyte and/or other gas(es) generated within the battery cell, e.g., due to a fault condition within the battery cell. In such an example, such vapor and/or gas may be released out of the battery cell. Examples of gases released from battery cells, such as lithium ion battery cells, include hydrogen, methane, ethane, methylene, propylene, carbon monoxide, carbon dioxide, and/or organic carbonates. In an example, the gases released from the battery cells may depend from the electrolyte and/or other materials used within the battery cells, and the type of battery cells (e.g., lithium ion battery cells or another appropriate type of battery cells).

In one embodiment, the outgas sensor 116a is configured to detect an outgas event in one or more battery cells of the plurality of battery cells 102a, . . . , 102n. For example, the outgas sensor 116a is mounted proximal to the battery cells 102, and the outgas sensor 116a monitors the gas space inside the enclosure 101. The gas(es) monitored by the outgas sensor 116a may be based on the type of the battery cells 102 used in the assembly 100. For example, if the battery cells 102 comprise lithium ion battery cells, then the outgas sensor 116a may monitor for vapor of lithium ion battery electrolyte and/or other gases potentially generated by such a battery cell during a fault condition. The outgas sensor 116a may detect gases from the battery cells 102 in parts per million (ppm) level detection threshold, for example.

In one embodiment, the outgas sensor 116a outputs a sense signal 117a. Once the outgas sensor 116a detects at least a threshold amount (e.g., a threshold ppm level) of gas leakage from one or more battery cells 102 (e.g., detects an outgas event), the sense signal 117a is indicative of such a detection. For example, upon detecting an outgas event, the sense signal 117a changes from a first signal level to a second signal level.

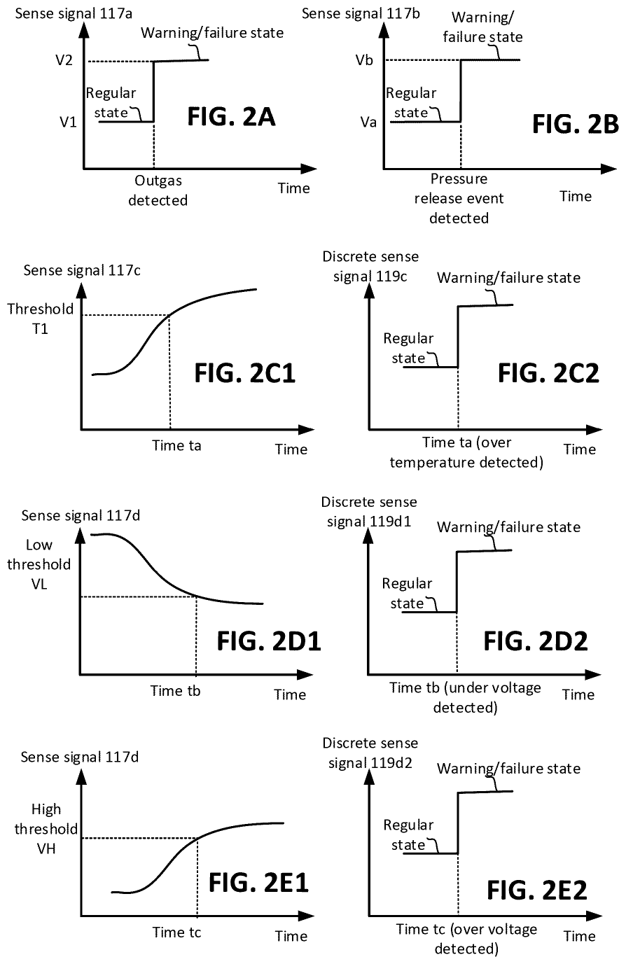

FIG. 2A illustrates a plot depicting a sense signal 117a output by an outgas sensor 116a of the battery assembly 100 of FIG. 1, in accordance with an embodiment of the present disclosure. The X-axis of the plot of FIG. 2A represents time and the Y axis of the plot of FIG. 2A represents the sense signal 117a. For example, when no outgas event is detected (e.g., detected outgas is zero or at least less than a threshold outgas level), the outgas sensor 116a may output the sense signal 117a at a first voltage V1 (e.g., 0.50 V DC (direct current)). Upon detecting an outgas event (e.g., detected outgas is equal to or higher than the threshold outgas level), the outgas sensor 116a may output the sense signal 117a at a second voltage level V2 (e.g., 3.0 V DC). Thus, the sense signal 117a provides indication of the outgas event.

The outgas event may be a warning or a failure state of the battery assembly 100. For example, in response to a detection of the outgas event, the system 180 and/or the processor 104 may shut down operations of the battery assembly 100, as described below.

In one embodiment, during an outgas event, the gas pressure within the enclosure 101 increases, e.g., due to vaporization of the electrolyte of one or more of the battery cells 102a, . . . , 102n, e.g., because of a fault condition within the one or more battery cells. In an example, the outgas sensor 116a detects such as outgas event, and indicates such detection through the sense signal 117a (e.g., by increasing the sense signal 117a from voltage V1 to voltage V2, see FIG. 2A). As described below, preventative actions may be taken (e.g., by the processor 104 and/or by the system 180), to remedy the situation causing the outgas event (e.g., by shutting down the battery cells 102a, . . . , 102n). However, in one example, the outgas detection and/or such remedial actions may not be sufficient or on time, and the gas pressure within the enclosure 101 may rise. Such rising gas pressure may cause thermal runaway, fire hazards, and/or structural damage to the enclosure 101.

Accordingly, in one embodiment, the enclosure 101 comprises a pressure relief device 108, where the sensor 116b is a pressure relief sensor 116b configured to sense a pressure release event caused by the pressure relief device 108. For example, the pressure relief device 108 within the enclosure 101 releases gas pressure from the enclosure 101, e.g., in response to the gas pressure within the enclosure 101 exceeding a threshold pressure value. In an example, the pressure relief device 108 is a burst disc or rapture disc mounted on a wall of the enclosure 101. A burst disc or a rupture disk is a pressure relief safety device that protects the system 100 from over pressurization and consequent fire hazards and/or structural damage. For example, the pressure relief device 108 has a non-reclosing, sacrificial part that is a one-time-use membrane or diaphragm. The diaphragm fails or ruptures at or above a predetermined differential pressure between the inside of the enclosure 101 and the ambient. For example, when the gas pressure inside of the enclosure 101 exceeds a threshold pressure, the diaphragm fails or ruptures (referred to herein as a pressure release event), thereby rapidly releasing the gas from within the enclosure 101, and thereby releasing or reducing the gas pressure within the enclosure 101. For example, the pressure relief device 108, when activated or ruptured, reduces the pressure within the enclosure 101 within a relatively small amount of time (e.g., within seconds or milliseconds or microseconds). In an example, once the diaphragm bursts, it may not be resealed, and the pressure relief device 108 may become non-operational until the diaphragm is repaired or replaced.

In one embodiment, the pressure relief sensor 116b senses a pressure release event caused by the pressure relief device 108. For example, the pressure relief sensor 116b outputs a sense signal 117b indicative of the pressure release event. In an example, the pressure relief sensor 116b may be integrated with the pressure relief device 108. For example, a rupture of the diaphragm of the pressure relief device 108 may be detected by the pressure relief sensor 116b.

FIG. 2B illustrates a plot depicting a sense signal 117b output by a pressure relief sensor 116b of the battery assembly 100 of FIG. 1, in accordance with an embodiment of the present disclosure. The X-axis of the plot represents time and the Y axis of the plot represents the sense signal 117b. For example, when no pressure release event is detected, the pressure relief sensor 116b may output the sense signal 117b at a first voltage Va (e.g., 0.50 V DC). Upon detecting a pressure release event, the pressure relief sensor 116b may output the sense signal 117b at a second voltage level Vb (e.g., 3.0 V DC). Thus, the sense signal 117b provides indication of the pressure release event.

The pressure release event may be a warning or a failure state of the battery assembly 100. For example, in response to a detection of the pressure release event, the system 180 and/or the processor 104 may shut down operations of the battery assembly 100, as described below.

Note that the sense signals 117a, 117b are discrete signals. For example, each of the sense signals 117a, 117b has two states. For example, as illustrated in FIG. 2A, a low value of the sense signal 117a implies that no outgas event (e.g., no warning or fault condition) is detected, and a high value of the sense signal 117a implies that an outgas event (e.g., a warning or a fault condition) has been detected. Similarly, as illustrated in FIG. 2B, a low value of the sense signal 117b implies that no pressure relief event (e.g., no warning or fault condition) is detected, and a high value of the sense signal 117b implies that a pressure relief event (e.g., a warning or a fault condition) has been detected.

In an example, in addition to the description with respect to FIGS. 2A and 2B, the sense signals 117a and/or 117b may also include additional data from the corresponding sensors 116a, 116b, respectively. For example, in addition to (or instead of) the high and low levels indicated in FIG. 2A, the sense signal 117a may also include a concentration (e.g., in the ppm level) of one or more outgases detected by the sensor 116a. Similarly, in an example, in addition to (or instead of) the high and low levels indicated in FIG. 2B, the sense signal 117b may also include a gas pressure experienced by the pressure relief device 108.

In an example, the sensor 116c is a temperature sensor to sense or monitor temperature of one or more locations within the enclosure 101. For example, the sensor 116c may sense temperature of one or more locations proximal to, or within, one or more of the battery cells 102a, . . . , 102n, within the processor 104, and/or of another appropriate location within the enclosure 101. In an example, the sense signal 117c generate by the sensor 116c is indicative of the measured temperature.

FIG. 2C1 illustrates a plot depicting a sense signal 117c output by a temperature sensor 116c of the battery assembly 100 of FIG. 1, in accordance with an embodiment of the present disclosure. FIG. 2C2 illustrates a plot depicting a discrete signal 119c generated by a comparator 118c, based on the sense signal 117c of FIG. 2C1, in accordance with an embodiment of the present disclosure.

For example, the enclosure 101 includes a plurality of comparators 118c, . . . , 118P, corresponding to the sensors 116c, . . . , 116P, respectively. In an example, each of the comparators 118c, . . . , 118P is configured to receive a corresponding sense signal 117, compare the sense signal 117 to one or more corresponding threshold values, and generate a corresponding discrete signal 119. For example, the comparator 118c receives the sense signal 117c from the sensor 116c, compares the sense signal 117c to a corresponding threshold value (e.g., threshold temperature T1), and generates a corresponding discrete sense signal 119c based on the comparison. The comparator 118d receives the sense signal 117d from the sensor 116d, compares the sense signal 117d to two corresponding threshold values (described below), and generates two corresponding discrete sense signals 119d1 and 119d2 based on the comparison. Similarly, the comparator 118P receives the sense signal 117P from the sensor 116P, compares the sense signal 117P to a corresponding threshold value, and generates a corresponding discrete sense signal 119P based on the comparison.

Note is there are no comparator 118a or 118b corresponding to the sense signals 117a and 117b from the sensors 116a and 116b, respectively. This is because, in one example, the sense signals 117a and 117b are inherently discrete signals, e.g., each having two states (see FIGS. 2A and 2B), such as the regular state, and the warning or failure state. Hence, there may not be a separate comparator to convert the sense signals 117a and 117b to corresponding discrete signals, in an example.

However, in some other examples and unlike FIG. 2A, the sense signal 117a may not be a discrete signal. In some such examples, the sense signal 117a may indicate a ppm level of the outgases, instead of detecting an outgas event. In some such examples, a comparator may compare the ppm level of the outgases with a threshold ppm level, to generate a corresponding discrete sense signal. When the ppm level is below the threshold ppm level, the discrete sense signal may be at a first state indicating normal functioning of the battery assembly 100 (e.g., as far as the outgases are concerned). If the ppm level exceeds the threshold ppm level, the comparator may transition the discrete sense signal to a second state, indicating the outgas event, e.g., similar to the sense signal 117a of FIG. 2A.

Referring now to FIG. 2C1, the X-axis of the plot represents time and the Y axis of the plot represents the sense signal 117c, which increases (e.g., increases proportionally or substantially linearly, or non-linearly, e.g., based on the type of temperature sensor used) with an increase in the temperature, and decreases with a decrease in temperature. In the example of FIG. 2C1, at time ta, the temperature exceeds a threshold temperature T1, which is reflected in the sense signal 117c.

Referring now to FIG. 2C2, the X-axis of the plot represents time and the Y axis of the plot represents the discrete temperature sense signal 119c. In one embodiment, the comparator 118c receives the sense signal 117c indicative of the sensed temperature from the sensor 116c, compares the sensed temperature to the threshold temperature T1, and generates a corresponding discrete temperature sense signal 119c. When the temperature level is below the threshold temperature T1, the discrete temperature sense signal may be at a first state (labelled as “regular state” in FIG. 2C2) indicating normal functioning of the battery assembly 100 (e.g., as far as temperature is concerned). Once the temperature exceeds the threshold temperature level T1 at time ta (see FIG. 2C1), the comparator 118c transitions the discrete temperature sense signal 119c to a second state (labelled as “warning/failure state” in FIG. 2C2), indicating an over-temperature event has occurred.

The over-temperature event may be a warning or a failure state of the battery assembly 100. For example, in response to a detection of the over-temperature event, the system 180 and/or the processor 104 may shut down operations of the battery assembly 100, as described below.

In an example, the sensor 116d is a voltage sensor measuring a voltage generated by one or more of the battery cells 102a, . . . , 102n. For example, the sensor 116d measures a voltage output by the battery assembly 100. FIG. 2D1 illustrates a plot depicting a voltage sense signal 117d output by a voltage sensor 116d of the battery assembly 100 of FIG. 1, in accordance with an embodiment of the present disclosure. FIG. 2D2 illustrates a plot depicting a discrete under-voltage signal 119d1 generated by a comparator 118d, based on the sense signal 117c of FIG. 2D1, in accordance with an embodiment of the present disclosure.

In one embodiment, the sensor 116d and the corresponding comparator 118d monitors the voltage output by the battery assembly 100, e.g., to detect an over-voltage or under-voltage condition. FIGS. 2D1 and 2D2 are associated with detecting an under-voltage condition, where the voltage goes below a low threshold voltage VL. Referring now to FIG. 2D1, the X-axis of the plot represents time and the Y axis of the plot represents the sense signal 117d, which increases or decreases (e.g., proportionally or substantially linearly, or non-linearly, e.g., based on the type of sensor used) with an increase or decrease, respectively, in the sensed voltage. In the example of FIG. 2D1, at time tb, the voltage goes below the low threshold voltage VL, which is reflected in the sense signal 117d.

Referring now to FIG. 2D2, the X-axis of the plot represents time and the Y axis of the plot represents the discrete under-voltage sense signal 119d1, which indicates possible under-voltage. In one embodiment, the comparator 118d receives the voltage sense signal 117d indicative of the sensed voltage, compares the sensed voltage to a low threshold voltage VL, and generates a corresponding discrete under-voltage sense signal 119d1. When the voltage level is above the threshold low voltage VL, the discrete under-voltage sense signal is at a first state (labelled as “regular state” in FIG. 2D2) indicating normal functioning of the battery assembly 100 (e.g., as far as under-voltage is concerned). Once the voltage is below the threshold low voltage VL at time tb (see FIG. 2D1), the comparator 118d transitions the discrete under-voltage sense signal 119d1 to a second state (labelled as “warning/failure state” in FIG. 2D2), indicating an under-voltage event has occurred.

FIG. 2E1 illustrates another plot depicting the voltage sense signal 117d output by the voltage sensor 116d of the battery assembly 100 of FIG. 1, in accordance with an embodiment of the present disclosure. FIG. 2E2 illustrates a plot depicting a discrete over-voltage signal 119d1 generated by a comparator 118d, based on the sense signal 117c of FIG. 2E1, in accordance with an embodiment of the present disclosure.

FIGS. 2E1 and 2E2 are associated with detecting an over-voltage condition, when the voltage goes above a high threshold voltage VH. Referring now to FIG. 2E1, the X-axis of the plot represents time and the Y axis of the plot represents the sense signal 117d. In the example of FIG. 2D1, at time tc, the voltage goes above the high threshold voltage VH, which is reflected in the sense signal 117d.

Referring now to FIG. 2E2, the X-axis of the plot represents time and the Y axis of the plot represents the discrete over-voltage sense signal 119d2, which indicates possible over-voltage output by the battery assembly. In one embodiment, the comparator 118d receives the voltage sense signal 117d indicative of the sensed voltage, compares the sensed voltage to a high threshold voltage VH, and generates a corresponding discrete over-voltage sense signal 119d1.

Thus, in an example and as illustrated in FIG. 1, the same comparator 118d compares the sensed voltage to both the low threshold voltage VL and the high threshold voltage VH. However, in another example, two different voltage comparators may be used-one for comparing the sensed voltage to the low threshold voltage VL, and another for comparing the sensed voltage to the high threshold voltage VH.

Referring again to FIG. 2E2, when the voltage level is below the threshold high voltage VH, the discrete over-voltage sense signal 119d2 is at a first state (labelled as “regular state” in FIG. 2E2) indicating normal functioning of the battery assembly 100 (e.g., as far as over-voltage is concerned). Once the voltage is above the threshold high voltage VH at time tc (see FIG. 2D1), the comparator 118d transitions the discrete over-voltage sense signal 119d1 to a second state (labelled as “warning/failure state” in FIG. 2E2), indicating an over-voltage event has occurred.

The over-voltage event and the under-voltage event may be warning or failure states of the battery assembly 100. For example, in response to a detection of the over-voltage event or the under-voltage event, the system 180 and/or the processor 104 may shut down operations of the battery assembly 100, as described below.

Thus, examples of pressure relief sensor 116a, outgas sensor 116b, temperature sensor 116c, and voltage sensor 116d are described herein above. In an example, the battery assembly may include any other appropriate sensor(s) to sense parameters that are related to safety and/or regular operation of the battery. Thus, for example, the battery assembly 100 many include any other appropriate type(s) of sensor(s). For example, in addition to (or instead of) one or more of the above described sensors, the battery assembly 100 may include addition sensors, such as current sensor (e.g., which, in combination with a corresponding comparator, may monitor for an over-current condition), a humidity sensor (e.g., which, in combination with a corresponding comparator, may monitor for an over-humid condition), and/or any other appropriate type of sensor(s) used within a battery assembly.

In FIG. 1, the comparators 118c, . . . , 118P are illustrated to receive the sense signals 117c, 117d, . . . , 117P, respectively, through the processor 104, and to transmit the generated discrete sense signals 119c, 119d, . . . , 119P to the processor. However, in some other examples, at least some of the comparators 118c, . . . , 118P may receive the corresponding sense signals 117c, 117d, . . . , 117P, respectively, directly from the sensors 116c, 116d, . . . , 116P, as described below.

Referring again to FIG. 1, in one embodiment, the sense signals 117a, . . . , 117P and the discrete sense signals 117c, . . . , 117P may be received by the processor 104 that is also within the enclosure 101. In an example, the processor 104 is a microcontroller. Although not illustrated, in an example, the processor 104 is coupled to a communication chip, e.g., for communicating with the sensors 116a, . . . , 116P, the comparators 118c, . . . , 118P, and/or for communicating with the system 180. In one embodiment, the processor 104 is coupled to a non-transient computer readable storage medium 105, such as a memory 105 or a data storage device 105 that is also within the enclosure 101. In one embodiment, the non-transient computer-readable storage medium 105 stores instructions or codes, which, when executed by the processor 104, cause the processor 104 to perform operations to protect the battery assembly 100 from various hazards, as described herein. In one embodiment, the processor 104 and/or the memory 105 are on a printed circuit board (PCB), where the PCB is mounted within the enclosure 101.

In one embodiment, the processor 104 receives the sense signals 117a, . . . , 117P and the discrete sense signals 117c, . . . , 117P, and transmits the sense signals 117a, 117b (which are inherently discrete in nature), the discrete sense signals 117c, . . . , 117P, and/or information associated therewith over communication link(s) 184 to the system 180 external to the enclosure 101.

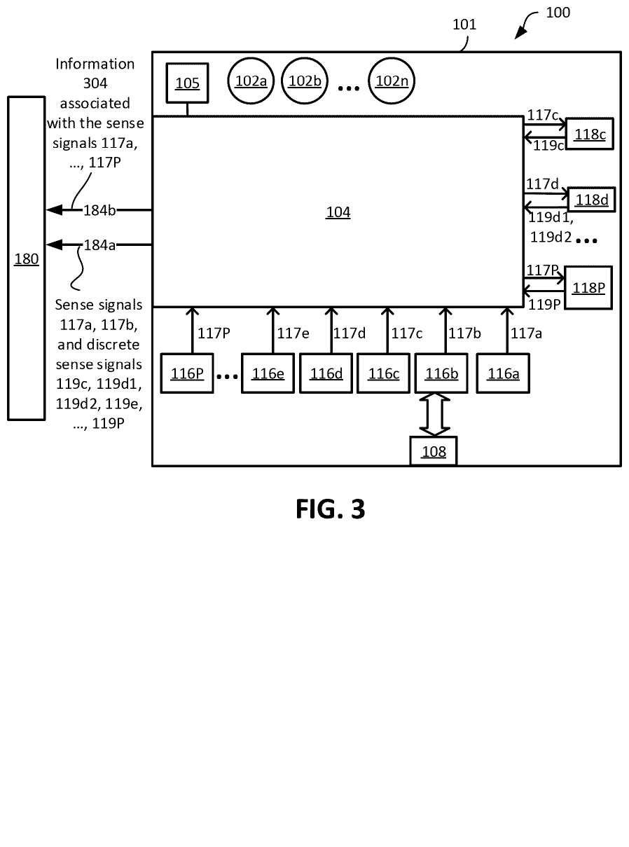

FIG. 3 illustrates communication between the processor 104 of the battery assembly 100 and the system 180 that is external to the enclosure 101, in accordance with an embodiment of the present disclosure. In the example of FIG. 3, the processor 104 is coupled to the system 180 via a first communication link 184a and a second communication link 184b. Thus, the communication links 184 of FIG. 1 comprise at least the first communication link 184a and the second communication link 184b of FIG. 3.

In one embodiment, the processor 104 transmits that sense signals 117a, 117b (which are inherently discrete in nature), and the discrete sense signals 119c, 119d1, 119d2, 119e, . . . , 119P over the communication link 184a. For example, the processor 104 doesn't alter or process the sense signals 117a, 117b (which are inherently discrete in nature), and the discrete sense signals 119c, 119d1, 119d2, 119e, . . . , 119P, and merely retransmits or forwards these discrete signals, as received from the sensors 116a, 116b, and the comparators 118c, 118d, . . . , 118P, to the system 180 over the communication link 184a. In an example, the retransmission of these discrete signals 117a, 117b, 119c, . . . , 119P may be performed by the processor 104, and/or by a dedicated hardware circuitry (not illustrated) that is coupled to the processor 104 and that receives and retransmits these discrete signals 117a, 117b, 119c, . . . , 119P.

Thus, the communication link 184a transmits discrete signals (e.g., signals that have on and off states, or “0” and “1” states, or two states as illustrated in FIGS. 2A, 2B, 2C2, 2D2, and 2E2). In an example, the discrete signals 117a, 117b, 119c, . . . , 119P transmitted over the communication link 184a comprises analog signals, such as analog discrete signals.

In an example, the processor 104 may also transmit information 304 associated with the sense signals 117a, . . . , 117P to the system 180, e.g., over the communication link 184b, as illustrated in FIG. 3. In an example, the communication link 184b is a digital bus, such as a Controller Area Network (CAN) bus, although the communication link 184b may use another appropriate communication protocol.

For example, the processor 104 processes the sense signals 117a, . . . , 117P and/or the discrete sense signals 119c, 119d1, 119d2, . . . , 119P, and generates the information 304. For example, appropriate software executing within the processor 104 processes the sense signals 117a, . . . , 117P and/or the discrete sense signals 119c, 119d1, 119d2, . . . , 119P, and generates the information 304.

The processor 104 transmits the information 304 to the system 180 over the communication link 184b. For example, the information 304 may include bits of digital data indicative of output of various sensors.

For example, for the outgas sense signal 117a, the information 304 may include a concentration of the outgases, types of the outgases detected, and/or other relevant information about the outgas event. In an example, for the pressure relief sense signal 117b, the information 304 may include a time stamp of when the pressure relief event occurred, a corresponding pressure that triggered the pressure relief event, and/or other relevant information about the pressure relief event.

In an example, for the temperature sense signal 117c, the information 304 may include the actual detected temperature, a temperature profile over time, a rate of rise of the temperature, and/or other relevant information about the sensed temperature. For example, the temperature sensor 116c may measure temperature of multiple locations within the battery assembly 100 (e.g., may comprise more than one underlying temperature sensor). If any of these temperatures go above the threshold temperature T1, the discrete temperature sense signal 119c may transition to the “warning/failure state,” but may not identify a location of the multiple locations for which the temperature has exceeded the threshold temperature and/or may not identify the actual temperature. In contrast, the information 304 may identify temperature of each of such multiple locations.

In an example, for the voltage sense signal 117d, the information 304 may include the actual detected voltage, and/or other relevant information about the sensed voltage. For example, the voltage sensor 116d may measure voltages of multiple groups of battery cells within the battery assembly 100. If, in an example, any of these voltages go below (or above) the threshold low voltage VL (or the threshold high voltage VH), the discrete under-voltage sense signal 119d1 (or the discrete over-voltage sense signal 119d2) may transition to the “warning/failure state,” but may not identify which group of cells has the under-voltage (or over-voltage) condition. In contrast, the information 304 may identify the actual voltages of each such groups of battery cells, in an example.

Thus, the discrete signals 117a, 117b, 119c, . . . , 119P (e.g., each comprising two corresponding states, such as the regular state, and the warning/failure state) provide rudimentary warnings about a failure (or warning) state of the battery assembly, and are analog and/or discrete signals generated by the sensors 116a, 116b and comparators 118c, . . . , 118P, respectively. On the other hand, in an example, the information 304 provides rich data on a variety of aspects for various parameters of the battery assembly 100. For example, the information 304 are digital data generated by the processor 104 (e.g., by software being executed within the processor), based on the sense signals 117a, . . . , 117P.

Thus, the system 180 receives sensor data via two independent and different communication paths from the enclosure 101—discrete signals over the communication link 184a, and digital information 304 over the communication link 184b. In case the processor 140 fails for some reason (e.g., over-heat or software issues), the processor 140 may not be able to generate the information 304 from the sense signals 117a, . . . , 117P. However, the processor 104 may be able to maintain some rudimentary level of operations, and may still be able to transmit the discrete signals 117a, 117b, 119c, . . . , 119P over the communication link 184a. Similarly, even if one of the communication links 184a, 184b fails, the other of the communication links 184a, 184b may be able to notify the battery status to the system 180. Thus, communicating sensor data via two independent and different communication paths from the enclosure 101 to the system 180 improves reliability and redundancy of notifying the system 180 about the status of various parameters of the battery assembly 100, in an example.

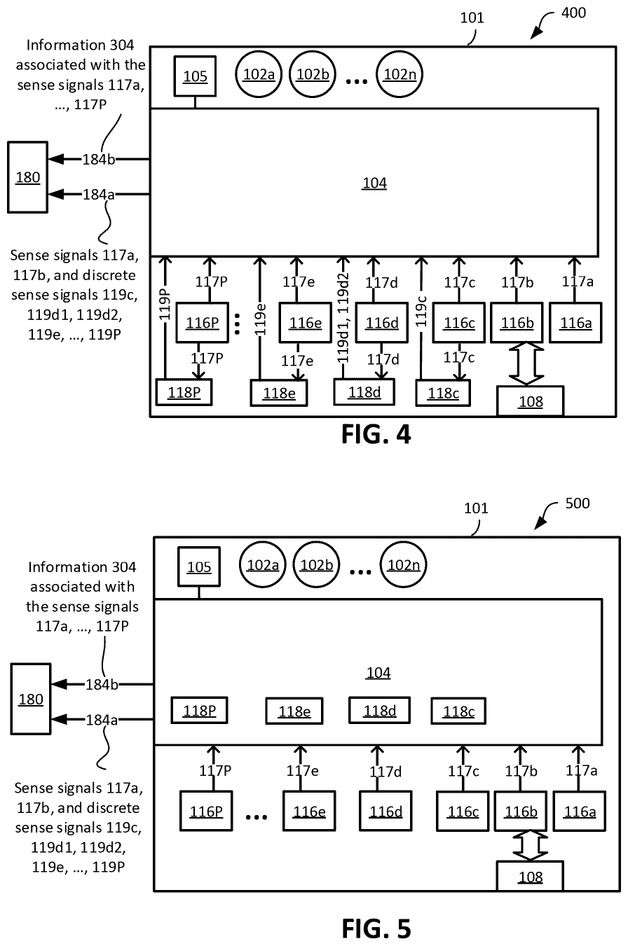

FIG. 4 illustrates a battery assembly 400 that is at least in part similar to the battery assembly 100 of FIGS. 1 and 3, wherein in the battery assembly 400 of FIG. 4, one or more comparators 118c, . . . , 118P receive corresponding sense signals 117c, 117d, . . . , 117P, respectively, directly from corresponding sensors 116c, 116d, . . . , 116P (e.g., by bypassing the processor 104), in accordance with an embodiment of the present disclosure.

Thus, in an example, in the battery assembly 400 of FIG. 4, a sensor 116i (where i=c, . . . , P) transmits the corresponding sense signal 117i to the corresponding comparator 118i (e.g., by bypassing the processor 104), and the comparator 118i generates the corresponding discrete signal 119i and transmits the discrete signal 119i (e.g., to the processor), for transmission of the discrete signal 119i to the system 180 over the communication link 184a. Thus, in this example, even if the processor 104 is non-functional, the sensors and the comparators can generate the discrete signals 117a, 117b, 119c, . . . , 119P, and transmit the discrete signals to the system 180 (e.g., assuming that the processor 104 can retransmit the discrete signals 117a, 117b, 119c, . . . , 119P to the system 180 over the communication link 184a).

Similar to FIG. 3, in FIG. 4 the system 180 receives sensor information via two paths—discrete signals over the communication link 184a, and digital information 304 the communication link 184b. In case the processor 140 fails for some reason (e.g., over-heat or software issues), the processor 140 may not be able to generate the information 304 from the sense signals 117a, . . . , 117P. However, the comparators 116c, . . . , 116P may still be functional, as the comparators 118c, . . . , 118P receive the corresponding sense signals 117c, . . . , 117P directly from the sensors 116a, . . . , 116P, respectively. Also, the processor 104 may be able to maintain some rudimentary level of operations, and may still be able to retransmit the discrete signals 117a, 117b, 119c, . . . , 119P over the communication link 184a. Similarly, even if one of the communication links 184a, 184b fails, the other of the communication links 184a, 184b may be able to notify the battery status to the system 180. This improves reliability and redundancy of notifying the system 180 about the status of various parameters of the battery assembly 100.

FIG. 5 illustrates a battery assembly 500 that is at least in part similar to the battery assemblies 100 and 400 of FIGS. 1 and 4, respectively, where in the battery assembly 500 of FIG. 5, one or more comparators 118c, . . . , 118P of the battery assembly are realized by the processor 104 (e.g., by software being executed within the processor 104) that is within the enclosure 101, in accordance with an embodiment of the present disclosure. Thus, in the battery assembly 500, a sensor 116i (where i=c, . . . , P) transmits the corresponding sense signal 117i to the processor 104, and the processor 104 implements the corresponding comparator 118i, e.g., through software. Thus, while the comparators 118 of FIGS. 1 and 4 are hardware based comparators, the comparators 118 of FIG. 5 are implemented using software.

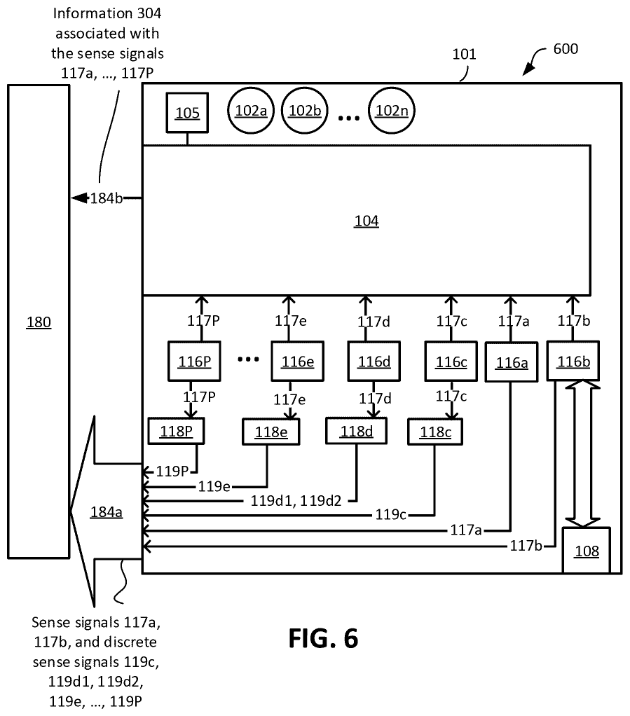

FIG. 6 illustrates a battery assembly 600 that is at least in part similar to the battery assemblies 100, 400, and 500 of FIGS. 1, 3, 4, and 5, wherein in the battery assembly 600 of FIG. 6, the discrete signals 117a, 117b, 119c, . . . , 119P are generated and transmitted over the dedicated communication link 184a (e.g., dedicated for transmission of the discrete signals, and not digital data) by bypassing the processor 104, in accordance with an embodiment of the present disclosure. For example, similar to FIG. 4, in the battery assembly 600 of FIG. 6, one or more comparators 118c, . . . , 118P receive corresponding sense signals 117c, 117d, . . . , 117P, respectively, directly from corresponding sensors 116c, 116d, . . . , 116P, e.g., by bypassing the processor 104. The comparators 118c, . . . , 118P generate the corresponding discrete sense signals 119c, 119d1, 119d2, 119e, . . . , 119P.

Subsequently, the discrete signals 117a, 117b, 119c, 119d1, 119d2, 119e, . . . , 119P are transmitted directly (or through a communication circuit, or a multiplexer, and/or another appropriate component, not illustrated in FIG. 6) to the system 180 over the communication link 184a, e.g., by bypassing the processor 104. Thus, the processor plays no role in generation and/or transmission of the discrete signals 117a, 117b, 119c, 119d1, 119d2, 119e, . . . , 119P. Rather, the sensors 116a, 116b generate and transmit the discrete signals 117a, 117b to the system 180 over the communication link 184a, e.g., by bypassing the processor 104. Similarly, the comparators 118c, . . . , 118P generate and transmit the discrete sense signals 119c, 119d1, 119d2, 119e, . . . , 119P to the system 180 over the communication link 184a, e.g., by bypassing the processor 104, in an example.

As also illustrated, the processor 104 receives the sense signals 117a, . . . , 117P, generates the information 304 associated with the sense signals 117a, . . . , 117P, and transmits the information 304 associated with the sense signals 117a, . . . , 117P to the system 180, e.g., over the communication link 184b.

Thus, in the example of FIG. 6, there are two independent and redundant circuits for transmitting the data from the sensors 116a, . . . , 116P to the system 180: a first one that bypasses the processor 104, and a second one that utilizes the processor 104. When the processor 104 is operating as intended, the system 180 receives detailed information 304 associated with the sense signals 117a, . . . , 117P over the communication link 184b from the processor 104, as well as receives discrete signals indicative of faults or warnings over the communication link 184a. In the unlikely event in which the processor 140 fails for some reason (e.g., over-heat or software issues), the system 180 still continues receiving fault warnings over the communication link 184a. Similarly, if the communication link 184a is non-operational for some reason, the system 180 continues receiving the information 304 from the processor 104 over the communication link 184b. This improves reliability and redundancy of notifying the system 180 about the status of various parameters of the battery assembly 100, as well as about possible warning or fault in the battery assembly 100.

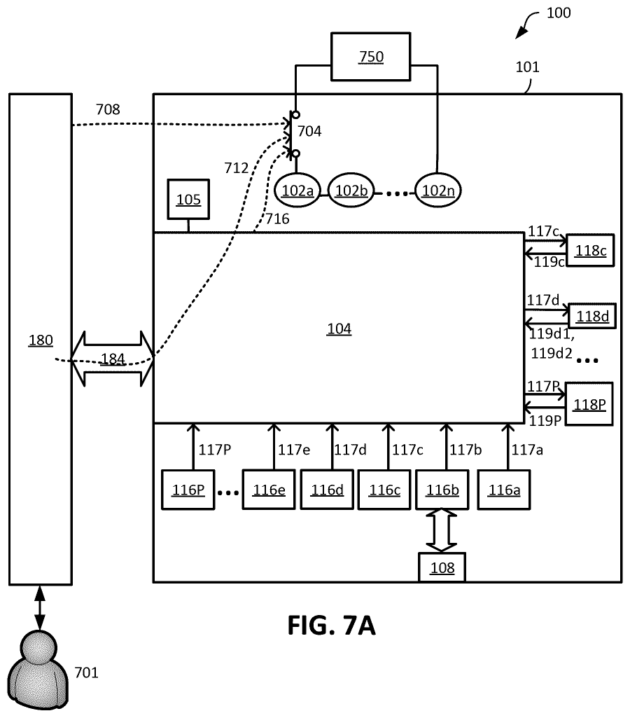

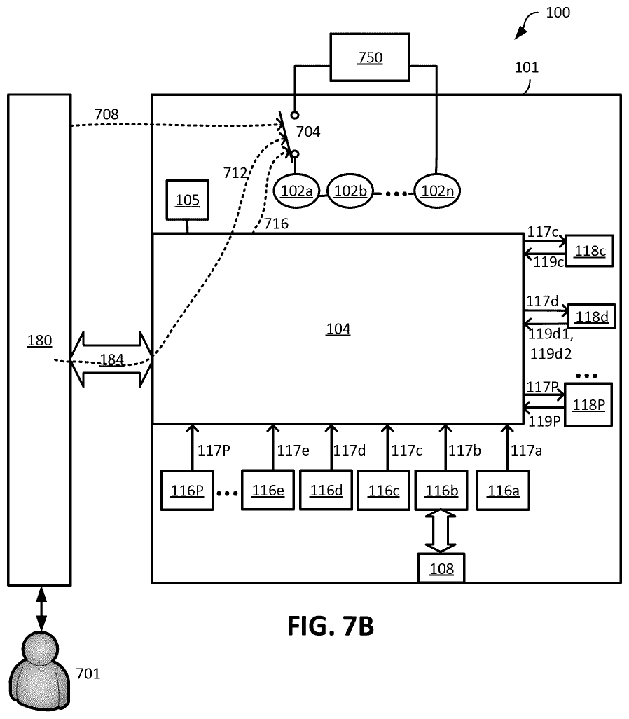

FIGS. 7A and 7B illustrate the battery assembly 100 of FIG. 1, along with operations of a switch 704 within the enclosure 101 of the battery assembly 100, where the switch 704 is operable to disconnect the plurality of battery cells 102a, . . . , 102n from a load 750 external to the enclosure 101, in response to detection of a warning or a fault event from the battery assembly 100, in accordance with an embodiment of the present disclosure.

Note that FIGS. 7A and 7B illustrate specific locations and operations of the comparators 118c, . . . , 118P similar to those of FIG. 1. In an example, FIGS. 7A and 7B can be modified to incorporate the teachings from FIGS. 3-6 described herein above. For example, locations and operations of the comparators 118c, . . . , 118P of FIGS. 7A and 7B can be modified to be similar to those described with respect to FIGS. 3-6. Similarly, the description of the communication links 184a, 184b with respect to FIGS. 3-6 may also be applicable to FIGS. 7A and 7B, in an example.

As illustrated in FIGS. 7A and 7B, the switch 704 couples the battery cells 102a, . . . , 102n to an external load 750 that is external to the enclosure 101. In an example, the switch 704 is a contactor, e.g., a device for making and breaking an electric circuit. The load 750 may be any appropriate type of load receiving DC power from the battery cells 102a, . . . , 102n.

In FIGS. 7A, 7B, the battery cells 102a, . . . , 102n are illustrated to be in series with the load 750, although this may not necessarily be the case. For example, a first battery cell may be parallel to a second battery cell, and the parallel combination may be in series with a third battery cell. Any other appropriate series/parallel combination of the battery cells 102a, . . . , 102n may also be possible.

The connection between the battery cells 102a, . . . , 102n and the load 750 is through the switch 704. Thus, when the switch 704 is closed (such as in FIG. 7A), the load 750 is coupled to the battery cells 102a, . . . , 102n. When the switch 704 is open (such as in FIG. 7B), the load 750 is disconnected from the battery cells 102a, . . . , 102n.

FIG. 7A illustrates a closed state of the switch 704 during normal operation of the battery assembly 100, e.g., when no battery warning or fault is detected. Examples of such battery warning or fault includes an outgas event, a pressure release event, an over-voltage or under-voltage event, an over-temperature event, and/or another failure event associated with the battery assembly. In one embodiment, such battery warning or fault may be indicated by (i) the sense signals 117a, 117b, and discrete sense signals 119c, 119d1, 119d2, 119e, . . . , 119P communicated over the communication link 184a, and/or (ii) the software generated digital information 304 communicated over the communication link 184b. FIG. 7B illustrates an open state of the switch 304, e.g., when any such battery warning or fault is detected.

In one embodiment, the switch 704 is controlled by one or more of control signals 708, 712, 716. Although FIGS. 7A, 7B illustrate three control signals 708, 712, 716, the battery assembly 100 may have any single one, or any two, or all three of the control signals 708, 712, 716, based on an implementation of the battery assembly 100.

In an example, the control signal 708 is generated and transmitted by the system 180 to the switch 704, e.g., bypassing the processor 104. Thus, the control signal 708 may be transmitted from the system 180 to the enclosure 101 and the switch 704 using a communication link that is different from the communication links 184a, 184b described with respect to FIGS. 1-6. In another example, the control signal 708 may be transmitted from the system 180 to the enclosure 101 and the switch 704 using the communication link 184a that bypasses the processor 104, e.g., see FIG. 6.

For example, the system 180 may receive the sense signals 117a, 117b, and discrete sense signals 119c, 119d1, 119d2, 119e, . . . , 119P over communication link 184a and/or may receive information 304 over communication link 184b, as described with respect to FIGS. 1-6. During normal operation of the battery assembly 100 (e.g., when no battery warning or fault has been detected), the control signal 708 may indicate to the switch 704 to be in the closed state, as seen in FIG. 7A, such that the load 750 receives power from the battery cells 102a, . . . , 102n through the switch 704.

In one embodiment, in response to the sense signals 117a, 117b, the discrete sense signals 119c, 119d1, 119d2, 119e, . . . , 119P, and/or the information 304 indicating one or more battery warning and/or fault events, the system 180 may change a state of the control signal 708, e.g., to indicate to the switch 704 to switch from the closed state to an open state, as seen in FIG. 7B. In the open state of operation of the switch 704, the load 750 is disconnected from the battery cells 102a, . . . , 102n by the switch 704. Because the battery cells 102a, . . . , 102n are now disconnected from the load 750, the battery cells 102a, . . . , 102n are now not loaded, which eliminates or reduces chances of thermal runaway and fire hazard from the reason(s) that caused the detected battery warning and/or fault event.

In an example, the control signal 712 is generated and transmitted by the system 180 to the switch 704, through the processor 104. Thus, while the control signal 708 is transmitted by the system 180 to the switch 704 directly (e.g., by bypassing the processor 104), the control signal 712 is transmitted by the system 180 to the switch 704 through the processor 104. For example, the control signal 712 is transmitted by the system 180 to the processor 104 through the communication link 184b and/or the communication link 184a described above, and then the processor 104 transmits the control signal 712 to the switch 704. In an example, the system 180 may transmit either the control signal 708, or the control signal 712, or both, to the switch 304.

In an example, the control signal 716 is generated and transmitted by the processor 104 to the switch 704, e.g., based on the processor 104 receiving the analyzing the sense signals 117a, . . . , 117P and/or the discrete sense signals 119c, . . . , 119P. Operation of the control signal 716 may be at least in part similar to the operation of the control signal 308 described above.

Thus, any one or both the processor 104 or the system 180 may control the switch 704, e.g., using one or more of the control signals 708, 712, and/or 716. In one embodiment and as described above, the system 180 may automatically control the switch 704 through the control signals 708 and/or 712.

In another example, a user 701 may interact with the system 180, e.g., to be informed about any possible battery warning and/or fault events (e.g., based on data received by the system 180 over the communication links 184a, 184b). In one embodiment, there may be a manual override that can be used by the user 701 to override the automatic controlling of the switch 704, and the user 701 may manually control the switch 704, e.g., through the system 180.

In an example, battery assembly 100 may be installed in a vehicle, such as a hybrid electric vehicle (HEV) or a battery electric vehicle (BEV), including a personal vehicle, such as a scooter, a car, a motorcycle, or a truck, or a commercial vehicle such as a truck or bus, a maritime vehicle such as a boat, Unmanned underwater vehicles (UUV) or submarine, or a military vehicle such as a tank, a self-propelled artillery, or a troop transport. In an example, the battery assembly 100 may be installed in an aircraft such as an airplane or a helicopter, an unmanned aerial vehicle (UAV), a missile system, a space craft, or another powered air vehicle.

For example, if the battery assembly 100 is installed in a vehicle (such as an aircraft), the battery assembly 100 has to adhere to various rigorous standards applicable to such a sensitive installation. Such installation of the battery assembly 100 may necessitate low probability of thermal runaway and/or fault of the battery assembly 100 and consequent low probability of fire hazards. In one embodiment, independent use of dual communication links 184a and 184b may improve reliability and redundancy of the notification system, to inform the system 180 about potential battery warnings and/or faults, as also described above. Delivering such battery warnings and/or fault events in time, and taking automatic actions such as opening of the switch 704, enables prevention or reduction of probability of thermal runaway events and consequent possibilities of fire hazards in the battery assembly 100.

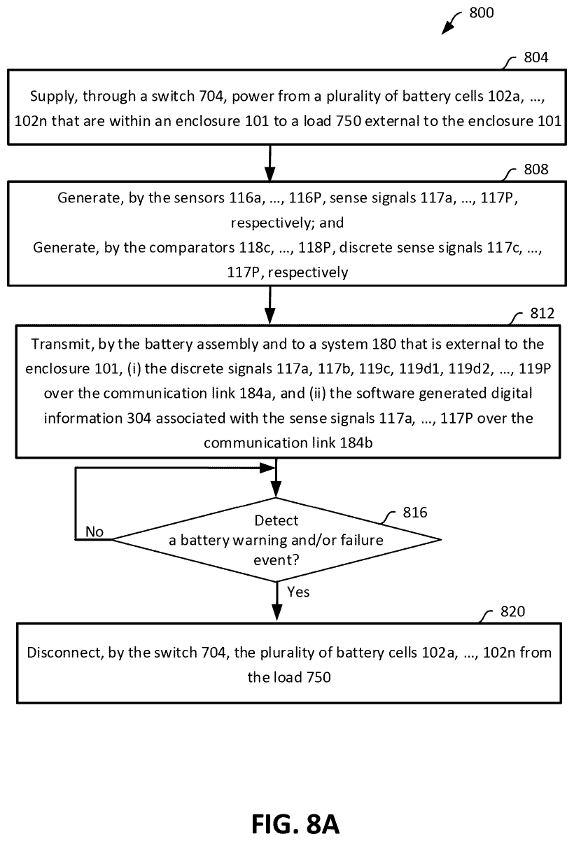

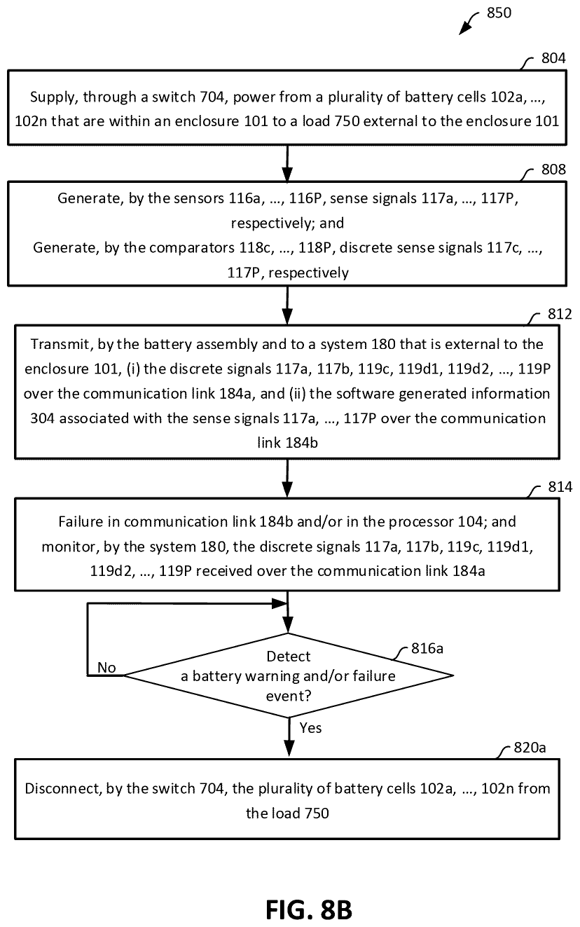

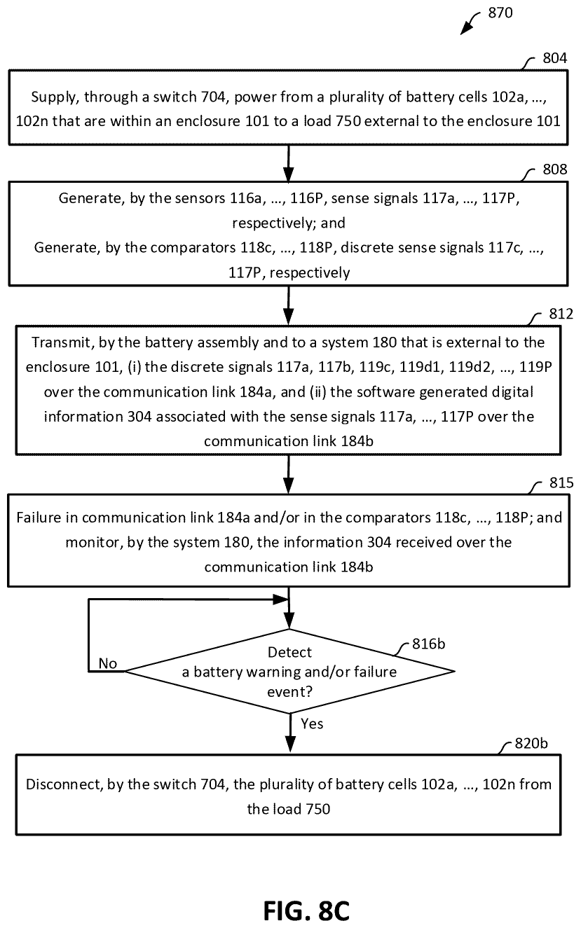

FIG. 8A illustrate a flowchart depicting a method 800 for operating the battery assembly of FIGS. 1, 3, 4, 5, 6, 7A and 7B, in accordance with an embodiment of the present disclosure. At 804 of the method 800, power is supplied, through the switch 704, from the plurality of battery cells 102a, . . . , 102n that are within an enclosure 101 to the load 750 external to the enclosure 101, e.g., as illustrated in FIG. 7A. For example, in FIG. 7A, the switch 704 is at the closed state, thereby supplying power from the plurality of battery cells 102a, . . . , 102n to the load 750.

The method 800 continues from 804 to 808. At 808, the sensors 116a, . . . , 116P generate the sense signals 117a, . . . , 117P, respectively, as described herein above. Also at 808, the comparators 118c, . . . , 118P receive the corresponding sense signals, and generate the discrete sense signals 117c, . . . , 117P, respectively, as also described herein above.

The method 800 continues from 808 to 812. At 812, data associated with the sense signals are transmitted by the battery assembly (e.g., any of the battery assemblies 100, 300, 400, 500, or 600) and to the system 180 that is external to the enclosure 101. For example, the battery assembly transmits, to the system 180, (i) the discrete signals 117a, 117b, 119c, 119d1, 119d2, . . . , 119P over the communication link 184a, and (ii) the software generated digital information 304 associated with the sense signals 117a, . . . , 117P over the communication link 184b.

For example, in the battery assembly 100 of FIGS. 1 and 3, the discrete signals 117a, 117b, 119c, 119d1, 119d2, . . . , 119P are transmitted by the processor 104 to the system 180 over the communication link 184a. On the other hand, in the battery assembly 600 of FIG. 6, the discrete signals 117a, 117b, 119c, 119d1, 119d2, . . . , 119P are transmitted to the system 180 over the communication link 184a, by bypassing the processor 104. Also, the information 304 are transmitted by the processor 104 to the system 180 over the communication link 184b.

The method 800 proceeds from 812 to 816, where the processor 104 and/or the system 180 detect if battery warning and/or failure event has occurred, e.g., based on monitoring the discrete signals 117a, 117b, 119c, 119d1, 119d2, . . . , 119P and/or the information 304.

If “No” at 816 (e.g., no battery warning and/or failure event has been detected), the method 800 loops back at 816, where the processor 104 and/or the system 180 continues to perform the detection. Note that the operations at 804, 808, 812, and 816 occur continuously during regular or normal operation of the battery assembly 100, e.g., until a positive detection has been made at 816.

If “Yes” at 816 (e.g., a battery warning and/or failure event has been detected), the method 800 proceeds from 816 to 820. At 820, the switch 704 disconnects the plurality of battery cells 102a, . . . , 102n from the load 750, e.g., as described with respect to FIG. 7B herein above. For example, one or more of the control signals 708, 712, 716 control operations of the switch 704, in response to the detection at 816, as described with respect to FIGS. 7A and 7B.

Note that the processes in method 800 are shown in a particular order for ease of description. However, one or more of the processes may be performed in a different order or may not be performed at all (and thus be optional), in accordance with some embodiments. Numerous variations on method 800 and the techniques described herein will be apparent in light of this disclosure.

FIG. 8B illustrate a flowchart depicting a method 850 for operating the battery assembly of FIGS. 1, 3, 4, 5, 6, 7A and 7B, in an event of (i) a failure in a communication link 184b between the processor 104 and the system 180, and/or (ii) a failure in the processor 104, in accordance with an embodiment of the present disclosure.

The method 850 of FIG. 8B comprises processes 804, 808, and 812, which are same as the corresponding processes of the method 800 of FIG. 8A, and accordingly, that previous relevant description is equally applicable here.

The method 850 of FIG. 8B proceeds from 812 to 814. At 814, a failure occurs in communication link 184b and/or in the processor 104. The failure may be due to any reason, such as overheating of the processor 104, software issues, stalling of the processor 104, and/or any appropriate reason(s) for which failure may occur in the communication link 184b and/or the processor 104. Accordingly, the system 180 ceases receiving the information 304 from the processor 104 over the communication link 184b. However, also at 814, the system 180 continues receiving and monitoring the sense signals 117a, 117b, and discrete sense signals 119c, 119d1, 119d2, 119e, . . . , 119P, which are received by the system 180 over the communication link 184a, as also described herein above.

The method 800 proceeds from 814 to 816a, where the system 180 detects if battery warning and/or failure event has occurred, e.g., based on monitoring the discrete signals 117a, 117b, 119c, 119d1, 119d2, . . . , 119P. In an example where the processor 104 has failed, the processor 104 cannot perform the detection at 816a. In another example if the processor 104 is at least in part operational, the processor 104 (e.g., in addition to, instead of, the system 180) may perform the detection at 816a.

If “No” at 816a (e.g., no battery warning and/or failure event has been detected), the method 800 loops back at 816a, where the system 180 (and the processor 104, if at least in part operational) continues to perform the detection.

If “Yes” at 816a (e.g., a battery warning and/or failure event has been detected), the method 800 proceeds from 816a to 820a. At 820a, the switch 704 disconnects the plurality of battery cells 102a, . . . , 102n from the load 750, e.g., as described with respect to FIG. 7B herein above. For example, if the processor 104 is non-operational, the system 180 issues the control signals 708 and/or 712, to cause the switch 704 to open, in response to the detection at 816a, as described with respect to FIGS. 7A and 7B. In another example, if the processor 104 is at least in part operational, the processor 104 may (e.g., in addition to, or instead of, the system 180) issue the control signal 716, to cause the switch 704 to open, in response to the detection at 816a, as described with respect to FIGS. 7A and 7B.

Note that the processes in method 850 are shown in a particular order for ease of description. However, one or more of the processes may be performed in a different order or may not be performed at all (and thus be optional), in accordance with some embodiments. Numerous variations on method 850 and the techniques described herein will be apparent in light of this disclosure.

FIG. 8C illustrate a flowchart depicting a method 870 for operating the battery assembly of FIGS. 1, 3, 4, 5, 6, 7A and 7B, in an event of (i) a failure in a communication link 184a between the enclosure 101 and the system 180, and/or (ii) a failure in one or more of the comparators 118c, . . . , 118P of the battery assembly, in accordance with an embodiment of the present disclosure.

The method 870 of FIG. 8C comprises processes 804, 808, and 812, which are same as the corresponding processes of the method 800 of FIG. 8A, and accordingly, that previous relevant description is equally applicable here.

The method 800 proceeds from 812 to 815. At 815, a failure occurs in the communication link 184a and/or in one or more of the comparators 118c, . . . , 118P. Accordingly, one or more of the discrete sense signals 119c, 119d1, 119d2, . . . , 119P may not generated. Accordingly, the system 180 ceases receiving one or more of the discrete sense signals 119c, 119d1, 119d2, 119e, . . . , 119P, and at least in part relies on the information 304 for fault event detection. Hence, at 815, the system 180 continues monitoring the information 304 received over the communication link 184b.

The method 800 proceeds from 815 to 816b, where the system 180 and/or the processor 104 detects if battery warning and/or failure event has occurred, e.g., based on monitoring the information 304. If “No” at 816b (e.g., no battery warning and/or failure event has been detected), the method 800 loops back at 816b, where the system 180 and/or the processor 104 continue to perform the detection.

If “Yes” at 816b (e.g., a battery warning and/or failure event has been detected), the method 800 proceeds from 816b to 820b. At 820b, the switch 704 disconnects the plurality of battery cells 102a, . . . , 102n from the load 750, e.g., as described with respect to FIG. 7B herein above. For example, the processor 104 and/or the system 180 issues the corresponding control signals 708, 712, and/or 716, to cause the switch 704 to open, in response to the detection at 816b, as described with respect to FIGS. 7A and 7B.

Note that the processes in method 870 are shown in a particular order for ease of description. However, one or more of the processes may be performed in a different order or may not be performed at all (and thus be optional), in accordance with some embodiments. Numerous variations on method 870 and the techniques described herein will be apparent in light of this disclosure.

### FURTHER EXAMPLE EMBODIMENTS

The following examples pertain to further embodiments, from which numerous permutations and configurations will be apparent.
Example 1. A battery assembly comprising: an enclosure including a plurality of battery cells; a sensor within the enclosure, the sensor configured to measure a parameter within the enclosure, and generate a sense signal; a processor within the enclosure, the processor configured to process the sense signal and generate information associated with the sense signal; a first communication link configured to transmit, from the enclosure to a system that is external to the enclosure, a discrete signal indicative of whether the sense signal indicates a fault condition; and a second communication link configured to transmit, from the enclosure to the system, a digital signal including the information associated with the sense signal.
Example 2. The battery assembly of example 1, wherein the sensor is a first sensor, the parameter is a first parameter, the sense signal is a first sense signal, the discrete signal is a first discrete signal, the information is a first information, and wherein the battery assembly further comprises: a second sensor within the enclosure, the second sensor configured to measure a second parameter within the enclosure, and generate a second sense signal; wherein the processor is configured to process the second sense signal, and generate second information that is associated with the second sense signal; wherein the first communication link is configured to transmit, from the enclosure to the system, a second discrete signal indicative of whether the second sense signal indicates a fault condition; and wherein the second communication link is configured to transmit, from the enclosure to the system, the digital signal that includes the second information associated with the second sense signal.
Example 3. The battery assembly of any one of examples 1-2, wherein the first communication link is an analog communication link between the processor and the system, and the second communication link is a digital communication link between the processor and the system.
Example 4. The battery assembly of any one of examples 1-3, wherein the second communication link is a Controller Area Network (CAN) bus between the processor and the system.
Example 5. The battery assembly of any one of examples 1-4, further comprising: a comparator configured to compare the sense signal with a threshold value of the parameter, and generate the discrete signal based on the comparison.
Example 6. The battery assembly of example 5, wherein the comparator is a part of the processor.
Example 7. The battery assembly of any one of examples 5-6, wherein: the first communication link is between the comparator and the system, bypassing the processor; and the second communication link is a digital communication link between the processor and the system.
Example 8. The battery assembly of any one of examples 1-7, wherein the information associated with the sense signal includes a value of the parameter.
Example 9. The battery assembly of any one of examples 1-8, wherein: the sensor is a voltage monitor, and the sense signal is indicative of a voltage of one or more battery cells of the plurality of battery cells; and the fault condition is one of an over-voltage or an under-voltage, where the monitored voltage is one of lower than a first threshold value or higher than a second threshold value, respectively.
Example 10. The battery assembly of any one of examples 1-8, wherein: the sensor is a temperature sensor configured to sense a temperature within the enclosure; and the fault condition is an over-temperature condition when the sensed temperature is above a threshold value.
Example 11. The battery assembly of any one of examples 1-8, wherein: the sensor is a pressure relief sensor, and sense signal is indicative of whether a pressure relief device within the enclosure has released gas pressure from the enclosure; and the fault condition is a pressure release event caused by the pressure relief device.
Example 12. The battery assembly of any one of examples 1-8, wherein: the sensor is an outgas sensor configured to sense to sense an outgas event of one or more battery cells of the plurality of battery cells; and the fault condition is an outgas event sensed by the outgas sensor.
Example 13. The battery assembly of any one of examples 1-12, further comprising: a switch within the enclosure, wherein the plurality of battery cells is coupled via the switch to a circuit external to the enclosure; wherein responsive to receiving a control signal generated in response to the discrete signal and/or the information indicating a fault condition, the switch is configured to disconnect the plurality of battery cells from the circuit external to the enclosure.
Example 14. A method of operating a battery assembly, the method comprising: outputting, by a sensor that is within an enclosure, a sense signal, in response to monitoring a parameter within the enclosure including a plurality of battery cells; generating, by a comparator, a discrete signal, based on the sense signal; generating, by a processor within the enclosure, information associated with the sense signal; transmitting, over a first communication path which bypasses the processor, the discrete signal to a system that is external to the enclosure; and transmitting, over a second communication path and by the processor, the information to the system.
Example 15. The method of example 14, wherein generating the discrete signal comprises: comparing, by the comparator, the sense signal to a threshold value of the parameter; and generating the discrete signal, based on the comparison.
Example 16. The method of any one of examples 14-15, further comprising one of: in response to being unable to transmit the discrete signal to the system, continuing to transmit, over the second communication path, the information to the system; or in response to being unable to transmit the information to the system, continuing to transmit, over the first communication path and by bypassing the processor, the discrete signal to the system.
Example 17. The method of any one of examples 14-16, wherein: outputting the sense signal comprises outputting the sense signal indicative of a voltage of one or more battery cells of the plurality of battery cells; generating the discrete signal comprises generating the discrete signal indicative of whether the sense signal indicates a fault condition; and the fault condition is one of an over-voltage or an under-voltage, where the voltage is one of lower than a first threshold value or higher than a second threshold value, respectively.
Example 18. The method of any one of examples 14-16, wherein: outputting the sense signal comprises outputting the sense signal indicative of a temperature within the enclosure; generating the discrete signal comprises generating the discrete signal indicative of whether the sense signal indicates a fault condition; and the fault condition is an over-temperature condition when the sensed temperature is above a threshold value.
Example 19. The method of any one of examples 14-16, wherein: outputting the sense signal comprises outputting the sense signal indicative of whether a pressure relief device within the enclosure has released gas pressure from the enclosure; generating the discrete signal comprises generating the discrete signal indicative of whether the sense signal indicates a fault condition; and the fault condition is a pressure release event caused by the pressure relief device.
Example 20. The method of any one of examples 14-16, wherein: outputting the sense signal comprises outputting the sense signal indicative of whether an outgas event has occurred in one or more battery cells of the plurality of battery cells; generating the discrete signal comprises generating the discrete signal indicative of whether the sense signal indicates a fault condition; and the fault condition is an outgas event sensed by the sensor.
Example 21. A battery assembly comprising: an enclosure; a plurality of battery cells within the enclosure; a sensor to generate a sense signal, based on monitoring a parameter associated with the plurality of battery cells; a comparator to compare the sense signal with a threshold value of the parameter, and to generate a discrete signal based on the comparison; and a processor to receive the sense signal, and to generate digital data based on the sense signal; wherein the battery assembly is (i) transmit the discrete signal from the comparator to a system that is external to the enclosure, and (ii) transmit the digital data from the processor to the system that is external to the enclosure.
Example 22. The battery assembly of example 21, wherein the battery assembly is to transmit the discrete signal from the comparator to the system, by bypassing the processor.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A battery assembly comprising:
an enclosure including a plurality of battery cells;
a sensor within the enclosure, the sensor configured to measure a parameter within the enclosure, and generate a sense signal;
a processor within the enclosure, the processor configured to process the sense signal and generate information associated with the sense signal;
a first communication link configured to transmit, from the enclosure to a system that is external to the enclosure, a discrete signal indicative of whether the sense signal indicates a fault condition; and
a second communication link configured to transmit, from the enclosure to the system, a digital signal including the information associated with the sense signal.

2. The battery assembly of claim 1, wherein the sensor is a first sensor, the parameter is a first parameter, the sense signal is a first sense signal, the discrete signal is a first discrete signal, the information is a first information, and wherein the battery assembly further comprises:
a second sensor within the enclosure, the second sensor configured to measure a second parameter within the enclosure, and generate a second sense signal;
wherein the processor is configured to process the second sense signal, and generate second information that is associated with the second sense signal;
wherein the first communication link is configured to transmit, from the enclosure to the system, a second discrete signal indicative of whether the second sense signal indicates a fault condition; and
wherein the second communication link is configured to transmit, from the enclosure to the system, the digital signal that includes the second information associated with the second sense signal.

3. The battery assembly of claim 1, wherein the first communication link is an analog communication link between the processor and the system, and the second communication link is a digital communication link between the processor and the system.

4. The battery assembly of claim 1, wherein the second communication link is a Controller Area Network (CAN) bus between the processor and the system.

5. The battery assembly of claim 1, further comprising:
a comparator configured to compare the sense signal with a threshold value of the parameter, and generate the discrete signal based on the comparison.

6. The battery assembly of claim 5, wherein the comparator is a part of the processor.

7. The battery assembly of claim 5, wherein:
the first communication link is between the comparator and the system, bypassing the processor; and
the second communication link is a digital communication link between the processor and the system.

8. The battery assembly of claim 1, wherein the information associated with the sense signal includes a value of the parameter.

9. The battery assembly of claim 1, wherein:
the sensor is a voltage monitor, and the sense signal is indicative of a voltage of one or more battery cells of the plurality of battery cells; and
the fault condition is one of an over-voltage or an under-voltage, where the monitored voltage is one of lower than a first threshold value or higher than a second threshold value, respectively.

10. The battery assembly of claim 1, wherein:
the sensor is a temperature sensor configured to sense a temperature within the enclosure; and
the fault condition is an over-temperature condition when the sensed temperature is above a threshold value.

11. The battery assembly of claim 1, wherein:
the sensor is a pressure relief sensor, and sense signal is indicative of whether a pressure relief device within the enclosure has released gas pressure from the enclosure; and
the fault condition is a pressure release event caused by the pressure relief device.

12. The battery assembly of claim 1, wherein:
the sensor is an outgas sensor configured to sense to sense an outgas event of one or more battery cells of the plurality of battery cells; and
the fault condition is an outgas event sensed by the outgas sensor.

13. The battery assembly of claim 1, further comprising:
a switch within the enclosure, wherein the plurality of battery cells is coupled via the switch to a circuit external to the enclosure;
wherein responsive to receiving a control signal generated in response to the discrete signal and/or the information indicating a fault condition, the switch is configured to disconnect the plurality of battery cells from the circuit external to the enclosure.

14. A method of operating a battery assembly, the method comprising:
outputting, by a sensor that is within an enclosure, a sense signal, in response to monitoring a parameter within the enclosure including a plurality of battery cells;
generating, by a comparator, a discrete signal, based on the sense signal;
generating, by a processor within the enclosure, information associated with the sense signal;
transmitting, over a first communication path which bypasses the processor, the discrete signal to a system that is external to the enclosure; and
transmitting, over a second communication path and by the processor, the information to the system.

15. The method of claim 14, wherein generating the discrete signal comprises:
comparing, by the comparator, the sense signal to a threshold value of the parameter; and
generating the discrete signal, based on the comparison.

16. The method of claim 14, further comprising one of:
in response to being unable to transmit the discrete signal to the system, continuing to transmit, over the second communication path, the information to the system; or
in response to being unable to transmit the information to the system, continuing to transmit, over the first communication path and by bypassing the processor, the discrete signal to the system.

17. The method of claim 14, wherein:
outputting the sense signal comprises outputting the sense signal indicative of a voltage of one or more battery cells of the plurality of battery cells;
generating the discrete signal comprises generating the discrete signal indicative of whether the sense signal indicates a fault condition; and
the fault condition is one of an over-voltage or an under-voltage, where the voltage is one of lower than a first threshold value or higher than a second threshold value, respectively.

18. The method of claim 14, wherein:
outputting the sense signal comprises outputting the sense signal indicative of a temperature within the enclosure;
generating the discrete signal comprises generating the discrete signal indicative of whether the sense signal indicates a fault condition; and
the fault condition is an over-temperature condition when the sensed temperature is above a threshold value.

19. The method of claim 14, wherein:
outputting the sense signal comprises outputting the sense signal indicative of whether a pressure relief device within the enclosure has released gas pressure from the enclosure;
generating the discrete signal comprises generating the discrete signal indicative of whether the sense signal indicates a fault condition; and
the fault condition is a pressure release event caused by the pressure relief device.

20. The method of claim 14, wherein:
outputting the sense signal comprises outputting the sense signal indicative of whether an outgas event has occurred in one or more battery cells of the plurality of battery cells;
generating the discrete signal comprises generating the discrete signal indicative of whether the sense signal indicates a fault condition; and
the fault condition is an outgas event sensed by the sensor.
